(19) United States
(12) Patent Application Publication
(10) Pub. No.: US 2017/0142190 A1
(43) Pub. Date: May 18, 2017

(54) BLADE SERVER

(71) Applicants: Inventec (Pudong) Technology Corporation, Shanghai (CN); INVENTEC CORPORATION, Taipei City (TW)

(72) Inventors: Song ZHANG, Shanghai (CN); Lan-Lan FANG, Shanghai (CN)

(21) Appl. No.: 15/057,687

(22) Filed: Mar. 1, 2016

(30) Foreign Application Priority Data
Nov. 18, 2015 (CN) 201510797328.5

(51) Int. Cl. H04L 29/08

(52) U.S. Cl. CPC H04L 67/10

(57) ABSTRACT

The invention provides a blade server, in which at least two server systems are integrated in a server system mother board, and a programmable design logic device is configured to switch to any one of said at least two server systems, so that an external device is kept in matching to only one of the at least two server systems in any operation instant.

### BACKGROUND OF INVENTION

1. Field of the Invention

The present invention relates to a server, and more particularly to a blade server.

2. Description of the Prior Art

Blade server means that the rack cabinet with the standard height be configured with multiple cassette-type server units, which can achieve the server platform having High-Availability High-Density with low cost. This design is specialized for specific industries and high-density computing environments. The blade server just like “blade”, wherein each “blade” is actually a system mother board.

The traditional blade server is configured with standard components, such as an case, a power supply, a mother board, storages, etc., but the internal processor is often unable to be compatible with old server architecture in interface and software, so that it makes more difficult for the old server to be upgraded. Thus, once these servers are operated over the life, the servers have no choice but being scrapped, thus, some available components will be wasted going with scrapping of the old servers.

In addition, the traditional server is configured with Intel E5 Series processor in general. The range of power consumption of the processor is usually between 95 W to 130 W, thus the power consumption is too large and to be applied for high-density integrated application.

Furthermore, the host case of the traditional server can accommodate with 42 1 U-type servers with approximately (U, 1 Unit=4.45 cm, height of one server), that is about 84˜168 Intel E5 Series processors, the integrated density is not high.

Nevertheless, the network function applied in the current blade server is low. In addition, the external network interface also occupies more space.

### SUMMARY OF THE INVENTION

One objective of the invention is to provide a blade server to satisfy the requirements of higher integration, saving space, and avoiding the waste of the available components and costs.

In order to solve the problems of prior art, the present invention provides a blade server, in which at least one server system mother board is configured. The server system mother board includes a first server system, a second server system, and a complex programmable logic device. The first server system includes a first processor, a first Platform Controller Hub and a first baseboard management controller. The first processor is electrically connected to at least one first memory slot. The first Platform Controller Hub is electrically connected to the first processor; and the first baseboard management controller is electrically connected to the first Platform Controller Hub. The second server system includes a second processor, a second Platform Controller Hub and a second baseboard management controller. The second processor is electrically connected to at least one second memory slot. The second Platform Controller Hub is electrically connected to the second processor; and the second baseboard management controller is electrically connected to the first south-bridge chip. The complex programmable logic device is electrically connected to the first Platform Controller Hub and the first baseboard management controller of the first server system and the second Platform Controller Hub and the second baseboard management controller of the second server system for switching a electrical connection between a external device and a server system, so that the external device is kept in matching to only one of the first server system and the second server system in any operation instant.

According to an embodiment of the present invention, the first server system further includes a first network controller, which is electrically connected to the first Platform Controller Hub and the first baseboard management controller.

According to an embodiment of the present invention, the first network controller is configured to transmit a serial input/output data to the first Platform Controller Hub, and further to transmit an internet signal to the first baseboard management controller for controlling a remote system management of the first server system.

According to an embodiment of the present invention, the second server system further includes a second network controller, which is electrically connected to the second Platform Controller Hub and the second baseboard management controller.

According to an embodiment of the present invention, the second network controller is configured to transmit a serial input/output data to the second Platform Controller Hub, and further to transmit an internet signal to the second baseboard management controller for controlling a remote system management of the second server system.

According to an embodiment of the present invention, the complex programmable logic device is electrically connected to the first Platform Controller Hub, the second Platform Controller Hub, the first baseboard management controller, and the second baseboard management controller.

According to an embodiment of the present invention, the complex programmable logic device is configured to transmit at least one of ESPI and LPC signals to the first Platform Controller Hub, the second Platform Controller Hub, the first baseboard management controller, and the second baseboard management controller.

According to an embodiment of the present invention, the complex programmable logic device is configured to transmit SGPIO signal to the first baseboard management controller and the second baseboard management controller.

According to an embodiment of the present invention, the server system mother board further includes a connector, and the server system mother board is electrically connected to a baseboard configured within one blade server through the connector.

According to an embodiment of the present invention, the server system mother board is electrically connected to a control-management board configured within the blade server for managing the server system mother board through the baseboard.

According to an embodiment of the present invention, the first Platform Controller Hub and the second Platform Controller Hub are configured to transmit storage signal to one hard disk backboard configured within the micro server, the hard disk backboard is configured with several hard disk drives.

According to an embodiment of the present invention, the server system mother board further includes a network switch chip, which is electrically connected to a network connector, the first baseboard management controller, and the second baseboard management controller for switching one of the internet signal of the first baseboard management controller and the internet signal of the second baseboard management controller to the network connector.

According to an embodiment of the present invention, the server system mother board further includes a multiplexer, which is applied to receive a VGA signal of the first baseboard management controller and the second baseboard management controller.

According to an embodiment of the present invention, the external device is VGA, USB, and or UART device.

Compared to the prior art, the blade server of the present invention integrates at least two server system in a server system mother board, and executes a switch function between server systems through sharing the programmable design logic device to make the external device keep in matching to only one server system in any operation instant. Furthermore, under the basis of satisfying the server function, the blade server according to present invention provides better performance about having higher integration, saving space occupied by server, and avoiding the waste of the available components and costs.

### BRIEF DESCRIPTION OF THE DRAWINGS

The detailed structure, operating principle and effects of the present invention will now be described in more details hereinafter with reference to the accompanying drawings that show various embodiments of the invention as follows.

The sole FIGURE is a circuit schematic view illustrating a system mother board of the blade server according to one embodiment of the present invention.

### DESCRIPTION OF THE PREFERRED EMBODIMENT

Reference may now be made in detail to particular embodiments of the present disclosure for the blade server, examples of which are illustrated in the accompanying drawings. Other advantages and features of the present disclosure will become readily apparent from claims and the detailed description of preferred embodiments below. The accompanying drawings are illustrative and not intended to be limiting, but are examples of embodiments of the disclosure, are simplified for explanatory purposes, and are not drawn to scale.

The blade server of the present invention integrates at least two server systems in a server system mother board, and executes a switch function between server systems through sharing the programmable design logic device to make an external device keep in matching to one server system in any operation instant. Furthermore, under the basis of satisfying the server function, the blade server according to present invention provides better performance about having higher integration, saving space occupied originally by server, and avoiding the waste of the available components and costs.

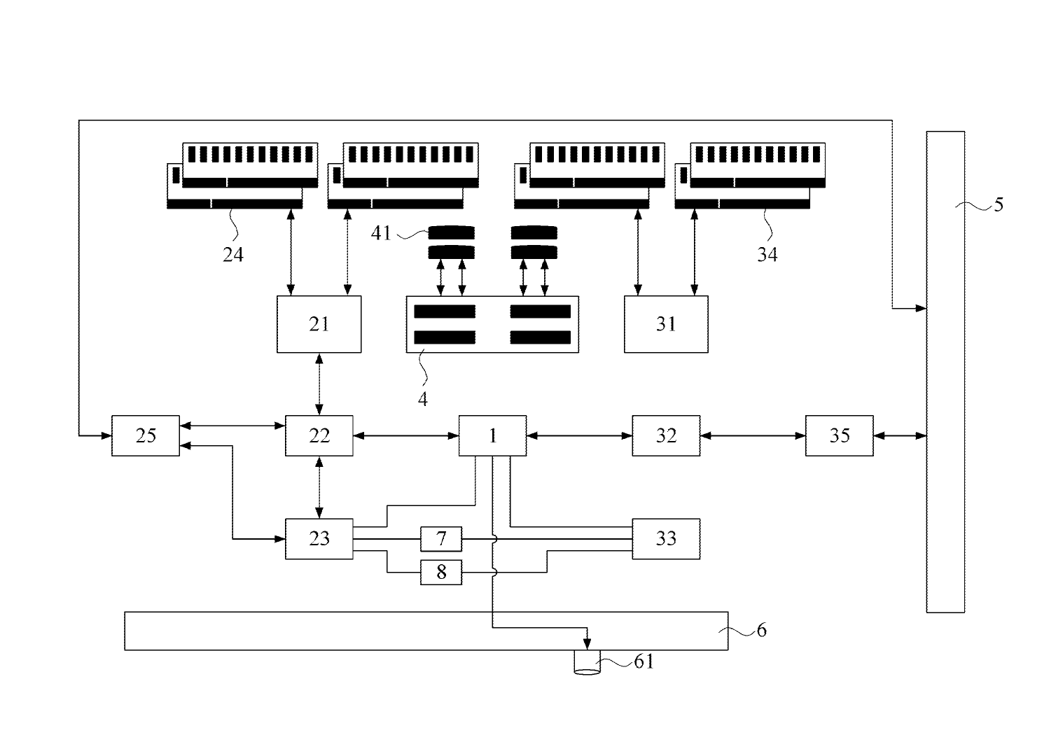

Referring to The sole FIGURE which is a circuit schematic view illustrating a system mother board of the blade server according to one embodiment of the present invention. As shown in FIG. 1, in one embodiment of the present invention, a blade server is provided. The blade server is configured with at least one server system mother board, which includes a first server system, a second server system, and a complex programmable logic device 1.

The first server system includes a first processor 21, a first Platform Controller Hub 22, and a first baseboard management controller 23. The first processor 21 is electrically connected to at least one first memory slot 24. The first Platform Controller Hub 22 is electrically connected to the first processor 21. The first baseboard management controller 23 is electrically connected to the first Platform Controller Hub 22.

Similarly, the second server system includes a second processor 31, a second Platform Controller Hub 32, and a second baseboard management controller 33. The second processor 31 is electrically connected to at least one second memory slot 34. The second Platform Controller Hub 32 is electrically connected to the second processor 31. The second baseboard management controller 33 is electrically connected to the second Platform Controller Hub 32.

The complex programmable logic device 1 is electrically connected to the first Platform Controller Hub 22 and the first baseboard management controller 23 of the first server system and the second Platform Controller Hub 32 and the second baseboard management controller 33 of the second server system for switching a electrical connection between the external device and one server system, so that the external device is kept in matching to only one of the first server system and the second server system in any operation instant.

In one embodiment of the present invention, the external device is VGA (Video Graphics Array), USB (Universal Serial Bus), UART (Universal Asynchronous Receiver/Transmitter), or other types of external device.

In one embodiment of the present invention, the blade server integrates at least two server systems in a server system mother board, and executes a switch function between server systems through sharing the programmable design logic device 1 to make the external device keep in matching to one server system in any operation instant. Furthermore, under the basis of satisfying the server function, the blade server according to present invention provides better performance about having higher integration, saves space occupied originally by server, and avoids the waste of the available components and costs in the basis for meeting the server function.

Further, each component of the server system mother board is applied to switch status information and control instructions, most components of the server system mother board are substantially the same as prior art, further description is omitted here for brevity. In one embodiment of the present invention, the first Platform Controller Hub 22 and the second Platform Controller Hub 32 are integrated with two channel memories, each supports two memory slots. Thus, the blade server can totally support four memory slots, i.e., can totally support to store data with 64 GB (Gigabyte).

The first server system further includes a first network controller 25. The first network controller 25 is electrically connected to the first Platform Controller Hub 22 and the first baseboard management controller 23. The first network controller 25 is applied to transmit serial input/output data to the first Platform Controller Hub 22. The first network controller 25 is applied to transmit the internet signal to the first baseboard management controller 23 for controlling the remote system management of the first server system.

Similarly, the second server system further includes a second network controller 35. The second network controller 35 is electrically connected to the second Platform Controller Hub 32 and second baseboard management controller 33. The second network controller 35 is applied to transmit serial input/output data to the second Platform Controller Hub 32. The second network controller 35 is applied to transmit the internet signal to the second baseboard management controller 33 for controlling the remote system management of the second server system.

The complex programmable logic device 1 is electrically connected to the first Platform Controller Hub 22, the second Platform Controller Hub 32, the first baseboard management controller 23, and the second baseboard management controller 33. The complex programmable logic device 1 is applied to transmit ESPI and/or LPC signal to the first Platform Controller Hub 22, the second Platform Controller Hub 32, the first baseboard management controller 23, and the second baseboard management controller 33. The complex programmable logic device is applied to transmit SGPIO signal to the first baseboard management controller 23 and the second baseboard management controller 33.

The server system mother board further includes a connector 5. The server system mother board is electrically connected to a baseboard configured within the micro server through connector 5, and the server system mother board is electrically connected to a control-management board configured within the micro server through baseboard for executing a management of the server system mother board.

The first Platform Controller Hub 22 and the second Platform Controller Hub 32 are applied to transmit storage signal to one hard disk backboard 4 configured within the micro server. The hard disk backboard 4 is configured with several hard disk drives 41 for saving space occupied originally by the system mother board. In one preferred embodiment of the present invention, the hard disk backboard 4 supports four hard disk drives (HHD) and six solid state drives (SSD).

The server system mother board further includes a network switch chip 7. The network switch chip 7 is electrically connected to a network connector, the first baseboard management controller 23, and the second baseboard management controller 33 for switching one of the internet signal of the first baseboard management controller 23 and the internet signal of the second baseboard management controller 33 to the network connector, so as to achieve individual network function respectively.

The server system mother board further includes a multiplexer 8, which is applied to receive VGA signal of the first baseboard management controller 23 and the second baseboard management controller 33.

The server system mother board further includes a front panel 6. The front panel 6 is configured with a node switching button 61, which is electrically connected to the complex programmable logic device 1. When the node switching button 61 is pressed, the connections between the external device and each server system are switched by the programmable design logic device 1. In one embodiment of the present invention, the case of the node switching button 61 is made of transparent material, and configured with light emitting diodes (LEDs), and the amount of LEDs are equal to the amount of the server system. The light colors of these light emitting diodes are different from each other, so that each of the light colors of these light emitting diodes can be applied to indicate the respective one of the server systems. The light emitting diodes are electrically connected to the complex programmable logic device 1. The complex programmable logic device 1 controls the corresponding light emitting diodes of the server system matched with the external device to light according to the connection between the external device and each server system. Whereby, the user can determine the external device is controlled by which server system through the light colors of the light emitting diodes.

In one embodiment of the present invention, the blade server further includes a host case, which is a 3 U-type host case (3 U means the blade server with 3 Units in height; i.e. height of 3 U blade server=4.45 cm×3), in which ten system mother boards are assembled to achieve higher integration.

While the present invention has been particularly shown and described with reference to a preferred embodiment, it will be understood by those skilled in the art that various changes in form and detail may be without departing from the spirit and scope of the present invention.

What is claimed is:

1. A blade server comprising at least one server system mother board, each of said at least one server system mother board comprising:
a first server system, comprising:
a first processor electrically connected to at least one first memory slot;
a first Platform Controller Hub electrically connected to the first processor; and
a first baseboard management controller electrically connected to the first Platform Controller Hub;
a second server system, comprising:
a second processor electrically connected to at least one second memory slot;
a second Platform Controller Hub electrically connected to the second processor; and
a second baseboard management controller electrically connected to the first Platform Controller Hub; and
a complex programmable logic device electrically connected to the first Platform Controller Hub and the first baseboard management controller of the first server system and the second platform Controller Hub and the second baseboard management controller of the second server system for switching an electrical connection between a external device and a server system, so that the external device is kept in matching to only one of the first server system and the second server system in any operation instant.

2. The blade server of claim 1, wherein the first server system further comprises a first network controller, the first network controller is electrically connected to the first Platform Controller Hub and the first baseboard management controller.

3. The blade server of claim 2, wherein the first network controller is configured to transmit a serial input/output data to the first Platform Controller Hub; and the first network controller is further configured to transmit an internet signal to the first baseboard management controller for controlling a remote system management of the first server system.

4. The blade server of claim 1, wherein the second server system further comprises a second network controller, the second network controller is electrically connected to the second Platform Controller Hub and the second baseboard management controller.

5. The blade server of claim 4, wherein the second network controller is configured to transmit a serial input/output data to the second Platform Controller Hub; and the second network controller is further configured to transmit an internet signal to the second baseboard management controller for controlling the remote system management of the second server system.

6. The blade server of claim 1, wherein the complex programmable logic device is configured to transmit at least one of ESPI and LPC signals to the first Platform Controller Hub, the second Platform Controller Hub, the first baseboard management controller, and the second baseboard management controller.

7. The blade server of claim 1, wherein the complex programmable logic device is configured to transmit SGPIO signal to the first baseboard management controller and the second baseboard management controller.

8. The blade server of claim 1, further comprising a connector applied to electrically connected the server system mother board to a baseboard configured within one blade server.

9. The blade server of claim 8, wherein the server system mother board is electrically connected to a control-management board configured within the blade server for managing the server system mother board through the baseboard.

10. The blade server of claim 1, wherein the first Platform Controller Hub and the second Platform Controller Hub are configured to transmit at least one storage signal to one hard disk backboard configured within a micro server, the hard disk backboard is configured with several hard disk drives.

11. The blade server of claim 1, further comprising a network switch chip electrically connected to a network connector, the first baseboard management controller, and the second baseboard management controller for switching one of at least one internet signal of the first baseboard management controller and at least one internet signal of the second baseboard management controller to the network connector.

12. The blade server of claim 1, further comprising a multiplexer applied to receive a VGA signal of the first baseboard management controller and the second baseboard management controller for reuse.

13. The blade server of claim 1, wherein the external device is VGA, USB, or UART device.
